(19) United States
(12) Patent Application Publication
(10) Pub. No.: US 2022/0379447 A1
(43) Pub. Date: Dec. 1, 2022

(54) Socket

(71) Applicant: KABO Tool Company, Taichung City (TW)

(72) Inventor: Chih-Ching Hsieh, Taichung City (TW)

(21) Appl. No.: 17/663,520

(22) Filed: May 16, 2022

(30) Foreign Application Priority Data
May 25, 2021 (TW) 110118867

(51) Int. Cl. B25B 23/00; B25B 13/06

(52) U.S. Cl. CPC B25B 23/0035; B25B 13/06

(57) ABSTRACT

A socket includes a socket body, a detent rod, and a pushing element. The socket body includes an opening, a teeth structure disposed on, and along the circumference of, the inner wall of the socket body, and an abutting structure farther away from the opening than is the teeth structure and including a first and a second through hole. The first through hole penetrates two sides of the abutting structure and is perpendicular to the axial direction of the socket body. The second through hole is at the center of the abutting structure and communicates with the first through hole. The detent rod is movably disposed through the first through hole and has a diminishing portion that tapers from two ends of the detent rod toward the center. The pushing element is movably disposed through the second through hole and has one end abutting against the diminishing portion.

### BACKGROUND OF THE INVENTION

### 1. Technical Field

The present disclosure relates to a socket and more particularly to a socket that allows a tool member engaged therewith to be rapidly removed therefrom.

### 2. Description of Related Art

The market has been supplied with many sockets that are designed to facilitate user operation, and various engaging structures have been developed to increase the strength with which a socket can engage with a tool member. However, when a tool member engaged with a conventional socket having such an engaging structure is no longer needed and is to be removed, the user must exert a greater force to remove the tool member than if the engaging structure were absent, and this causes inconvenience of use.

In view of the above, it remains one of socket manufacturers' goals to develop a socket that allows rapid removal of a tool member engaged with the socket.

### BRIEF SUMMARY OF THE INVENTION

One objective of the present disclosure is to provide a socket in which a detent rod and a pushing element are so configured and arranged that a user can drive the pushing element with the detent rod in order to push a tool member out of engagement with the socket body, thereby reducing the difficulty of removing the tool member from the socket.

According to one embodiment of the present disclosure, a socket includes a socket body, a detent rod, and a pushing element. The socket body includes an opening, a teeth structure, and an abutting structure. The teeth structure is disposed on, and along the circumference of, the inner wall of the socket body. The abutting structure is farther away from the opening than is the teeth structure, and the abutting structure includes a first through hole and a second through hole. The first through hole penetrates two sides of the abutting structure and is perpendicular to the axial direction of the socket body. The second through hole is located at the center of the abutting structure, communicates with the first through hole, and is perpendicular to the first through hole. The detent rod is movably disposed through the first through hole, and the detent rod has a diminishing portion. The diminishing portion tapers from the two ends of the detent rod toward the center of the detent rod. The pushing element is movably disposed through the second through hole, and the pushing element has one end abutting against the diminishing portion of the detent rod.

When a user pushes one end of the detent rod from either end of the first through hole, the diminishing portion of the detent rod applies a force to the pushing element such that the pushing element is moved toward the opening and thereby pushes a tool member engaged with the socket, allowing rapid removal of the tool member. Thus, the difficulty of removing the tool member from the socket is reduced.

The socket according to the foregoing embodiment may be so designed that the diminishing portion has a sectional shape resembling a wedge-shaped recess.

The socket according to the foregoing embodiment may be so designed that the pushing element includes a domed portion and a columnar body, that the domed portion is located at the aforesaid end of the pushing element and abuts against the diminishing portion of the detent rod, and that the columnar body is connected to the domed portion.

The socket according to the foregoing embodiment may be so designed that the abutting structure further includes a positioning structure, and that the positioning structure is located at the end of the second through hole that is the closer to the opening. When the greatest width of the domed portion is RA, and the positioning structure has an inner diameter RL, the condition of RL<RA is satisfied.

The socket according to the foregoing embodiment may be so designed that the other end (hereinafter referred to as the second end) of the pushing element has a greatest width greater than the diameter of the second through hole.

The socket according to the foregoing embodiment may be so designed that the pushing element includes a bottom portion located at the second end of the pushing element.

The socket according to the foregoing embodiment may be so designed that the pushing element further includes a bottom portion and an elastic element, that the bottom portion is located at the second end of the pushing element, and that the elastic element is connected between the columnar body and the bottom portion or between the columnar body and the domed portion.

The socket according to the foregoing embodiment may be so designed that the detent rod includes a rod body and a cover member, that the rod body includes the diminishing portion, and that the cover member is detachably connected to the rod body.

The socket according to the foregoing embodiment may be so designed that each of the two ends of the detent rod has an engaging portion, that the abutting structure further includes two position-limiting grooves, and that the position-limiting grooves are disposed in the two sides of the abutting structure respectively and correspond to the two ends of the first through hole respectively. When the greatest width of each engaging portion of the detent rod is RC, and the diameter of the first through hole is R1, the condition of R1<RC is satisfied.

The socket according to the foregoing embodiment may be so designed that the socket further includes a stop ring, that the teeth structure includes a groove, and that the groove is provided in, and along the circumference of, the teeth structure, with the stop ring disposed in the groove.

### BRIEF DESCRIPTION OF THE SEVERAL VIEWS OF THE DRAWINGS

FIG. 1 is a perspective view of the socket according to an embodiment of the present disclosure;

FIG. 2 is an exploded perspective view of the socket according to the embodiment shown in FIG. 1;

FIG. 3 is a sectional view of the socket according to the embodiment shown in FIG. 1, taken along line 3-3;

FIG. 4 is similar to FIG. 3 except that the detent rod is pushed by an applied force; and

FIG. 5 shows the pushing element in another embodiment of the present disclosure.

### DETAILED DESCRIPTION OF THE INVENTION

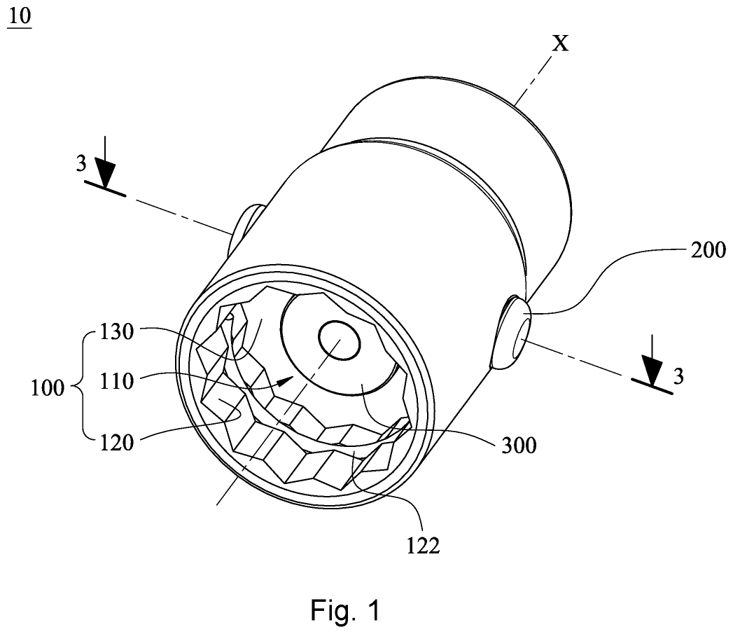

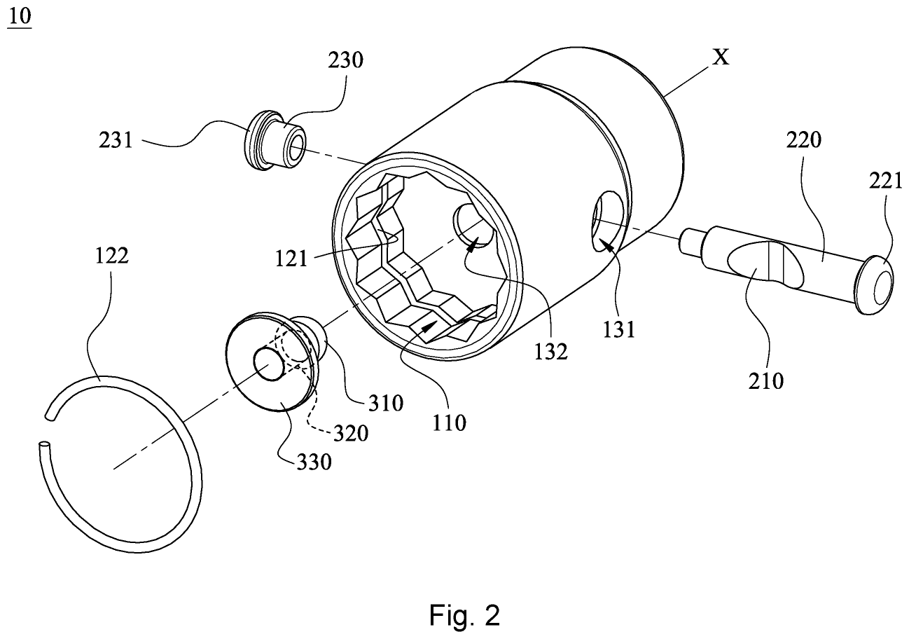

Please refer to FIG. 1 and FIG. 2 respectively for a perspective view of the socket 10 according to an embodiment of the present disclosure and an exploded perspective view of the socket 10 according to the embodiment shown in FIG. 1. As shown in FIG. 1 and FIG. 2, the socket 10 includes a socket body 100, a detent rod 200, and a pushing element 300. The socket body 100 has a central axis X and includes an opening 110, a teeth structure 120, and an abutting structure 130. The teeth structure 120 is disposed on, and along the circumference of, the inner wall (not indicated by a reference numeral in the drawings) of the socket body 100. The abutting structure 130 is farther away from the opening 110 than is the teeth structure 120. The abutting structure 130 includes a first through hole 131 and a second through hole 132. The first through hole 131 penetrates two opposite sides of the abutting structure 130 and is perpendicular to the axial direction (i.e., the direction of the central axis X) of the socket body 100. The second through hole 132 is located at the center of the abutting structure 130, is in communication with the first through hole 131, and is perpendicular to the first through hole 131. The detent rod 200 is movably disposed through the first through hole 131, and the detent rod 200 has a diminishing portion 210. The diminishing portion 210 tapers from the two ends of the detent rod 200 toward the center of the detent rod 200. The pushing element 300 is movably disposed through the second through hole 132, and the pushing element 300 has one end abutting against the diminishing portion 210 of the detent rod 200.

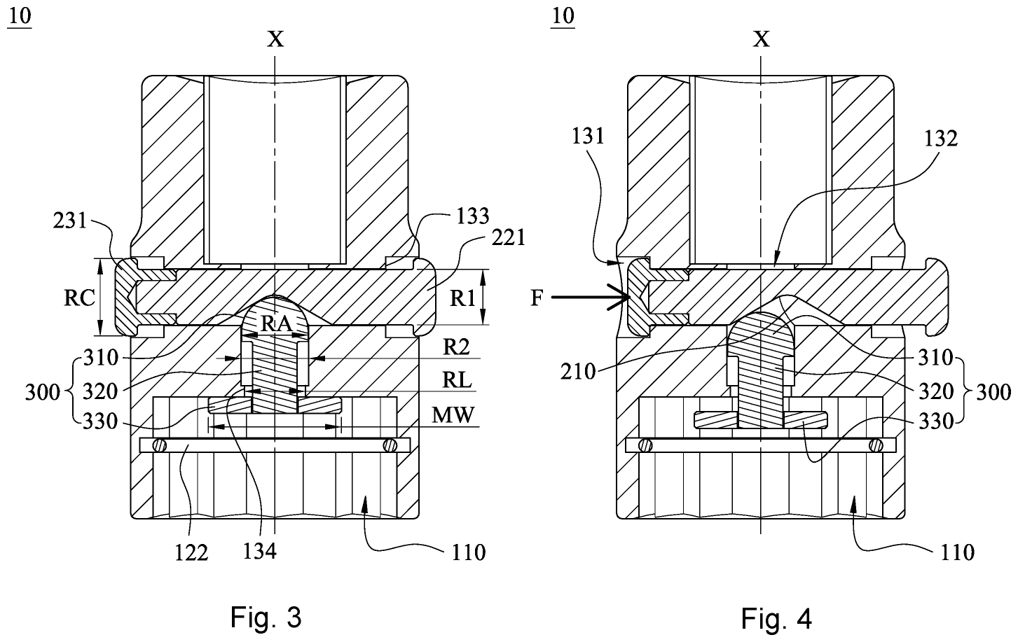

The socket 10, or more particularly its teeth structure 120, can engage with a tool member (not shown) inserted into the opening 110. The detent rod 200 and the pushing element 300 are so configured and arranged that when a user pushes the detent rod 200 at either end, the diminishing portion 210 of the detent rod 200 will apply to the pushing element 300 a force that acts toward the opening 110 and is tilted at an angle (not indicated by a reference numeral in the drawings) with respect to the central axis X, in order for the pushing element 300 to apply to the tool member a force acting toward the opening 110 to facilitate removal of the tool member. (The actions of the detent rod 200 and of the pushing element 300 will be detailed further below with reference to FIG. 3 and FIG. 4.) Thus, the difficulty of removing the tool member from the socket 10 is reduced.

More specifically, the socket 10 may further include a stop ring 122, and the teeth structure 120 may include a groove 121. The groove 121 is disposed in, and along the circumference of, the teeth structure 120. The stop ring 122 is disposed in the groove 121. More specifically, the shape of the stop ring 122 may be changed to a polygonal or circular one to meet user needs, and the material of the stop ring 122 may be an elastic material or metal; the present disclosure has no limitation in either regard. In the embodiment shown in FIG. 1, the stop ring 122 is a C-clip made of an elastic material to increase the strength with which the teeth structure 120 can engage with a tool member.

As shown in FIG. 2, the detent rod 200 may include a rod body 220 and a cover member 230. The rod body 220 includes the diminishing portion 210, and the cover member 230 is detachably connected to the rod body 220. The rod body 220 and the cover member 230 are configured and arranged to facilitate assembly of the socket 10 without affecting the structure of the diminishing portion 210. In the embodiment shown in FIG. 2, the rod body 220 and the cover member 230 form the two ends of the detent rod 200 respectively once engaged/connected with each other. In other embodiments of the present disclosure, however, the detent rod may be an integrally formed rod to simplify the manufacturing process of the detent rod. The present disclosure has no limitation on whether the detent rod is assembled from multiple components or integrally formed.

Please also refer to FIG. 3 for a sectional view of the socket 10 according to the embodiment shown in FIG. 1, taken along line 3-3. As shown in FIG. 2 and FIG. 3, the diminishing portion 210 may have a sectional shape resembling a wedge-shaped recess in order for the diminishing portion 210 to apply a force to the pushing element 300 more steadily than without such a sectional shape. Furthermore, each of the two ends of the detent rod 200 may have an engaging portion 221, 231. In the embodiment shown in FIG. 2, the engaging portion 221 is located at one end of the rod body 220, and the engaging portion 231 is located at the end of the cover member 230 that faces away from the rod body 220; the present disclosure, however, is not limited by this arrangement. Moreover, the abutting structure 130 may further include two position-limiting grooves 133 as shown in FIG. 3. The two position-limiting grooves 133 are disposed in the two opposite sides of the abutting structure 130 respectively and correspond to the two ends of the first through hole 131 respectively. The position-limiting grooves 133 serve to receive the engaging portions 221 and 231 respectively while allowing the engaging portions 221 and 231 to be moved. When each of the engaging portions 221 and 231 of the detent rod 200 has a greatest width RC, and the first through hole 131 has a diameter R1, the condition of R1<RC is satisfied. The engaging portions 221 and 231 are configured to prevent the detent rod 200 from moving out of the first through hole 131 by accident when a user applies an excessively great force to push the detent rod 200. Thus, the position-limiting grooves 133 and the engaging portions 221 and 231 contribute to the stability of use of the detent rod 200.

More specifically, when the detent rod 200 is pushed and consequently moved by an applied force, the position-limiting grooves 133 help stabilize the moving direction of the engaging portions 221 and 231, and the depth of each position-limiting groove 133 in a direction perpendicular to the central axis X provides room in which the detent rod 200 can be moved when pushed by the applied force (i.e., the depth of each position-limiting groove 133 in the direction perpendicular to the central axis X defines the greatest distance for which the detent rod 200 can be moved when pushed by the applied force); as a result, the stability of movement of the detent rod 200 is enhanced. Furthermore, the position-limiting grooves 133 are configured to prevent the detent rod 200 from being exposed from the socket body 100 to an excessive extent, lest the smoothness of use of the socket 10 be compromised.

The pushing element 300 may include a domed portion 310 and a columnar body 320. The domed portion 310 is located at the aforesaid end of the pushing element 300 and abuts against the diminishing portion 210 of the detent rod 200. The columnar body 320 is connected to the domed portion 310. More specifically, the surface with which the domed portion 310 abuts against the diminishing portion 210 is a hemispherical curved surface, the objective being for the surface with which the domed portion 310 contacts the diminishing portion 210 to be perpendicular to the force applied by the diminishing portion 210 to the domed portion 310, thereby ensuring the continuity of force application to the pushing element 300 so that the pushing element 300 is subjected to the applied force stably.

The abutting structure 130 may further include a positioning structure 134. The positioning structure 134 is located at the end of the second through hole 132 that is the closer to the opening 110. When the domed portion 310 has a greatest width RA, and the positioning structure 134 has an inner diameter RL, the condition of RL<RA is satisfied. The positioning structure 134 is configured to prevent the domed portion 310 from moving out of the second through hole 132. In other words, the positioning structure 134 limits the distance for which the pushing element 300 can be moved in the second through hole 132 along the central axis X, lest the pushing element 300 separate from the socket body 100 along with a tool member that is being disengaged and removed from the socket 10. Thus, the positioning structure 134 contributes to the stability of use of the pushing element 300.

As shown in FIG. 3, the other end of the pushing element 300 (i.e., the end that is the closer to the opening 110, hereinafter referred to as the second end of the pushing element 300) has a greatest width MW, and the greatest width MW is greater than the diameter R2 of the second through hole 132 to increase the area over which the pushing element 300 can push a tool member. The pushing element 300 may further include a bottom portion 330. The bottom portion 330 is located at the second end of the pushing element 300. More specifically, the bottom portion 330 may be detachably or integrally connected to the columnar body 320; the present disclosure has no limitation in this regard. In the embodiment shown in FIG. 3, the bottom portion 330 is detachably connected to the columnar body 320 to facilitate installation of the pushing element 300. More specifically, the greatest width MW of the pushing element 300 is the width of the bottom portion 330, but the present disclosure is not limited by this configuration. Moreover, the bottom portion 330 may be a disc-shaped structure in order for the pushing element 300 to push a tool member evenly.

Please refer to FIG. 4 for a sectional view that shows the detent rod 200 in FIG. 3 being pushed by an applied force F. As shown in FIG. 4, when a user applies the force F to the detent rod 200 from one of the two ends of the first through hole 131, the detent rod 200 is pushed by the force F and thus moved in the first through hole 131 in a direction perpendicular to the central axis X. As a result, the diminishing portion 210 applies through its wedge-shaped recess surface to the domed portion 310 of the pushing element 300 a force that acts toward the opening 110 and is tilted at an angle with respect to the central axis X. Due to the configuration and arrangement of the pushing element 300 and the second through hole 132, the static frictional stress applied by the wall of the second through hole 132 to the pushing element 300 initially cancels the force applied to the pushing element 300 in the direction perpendicular to the central axis X. Once the force applied to the pushing element 300 in the direction perpendicular to the central axis X exceeds the maximum static frictional force applied by the wall of the second through hole 132 to the pushing element 300, the pushing element 300 is moved toward the opening 110 in a direction parallel to the central axis X. Thus, the pushing element 300 can push a tool member engaged with the socket 10 toward the opening 110 with the disc-shaped bottom portion 330, allowing the tool member to be removed from the socket 10 rapidly, thereby making it easier for the user to remove the tool member from the socket 10.

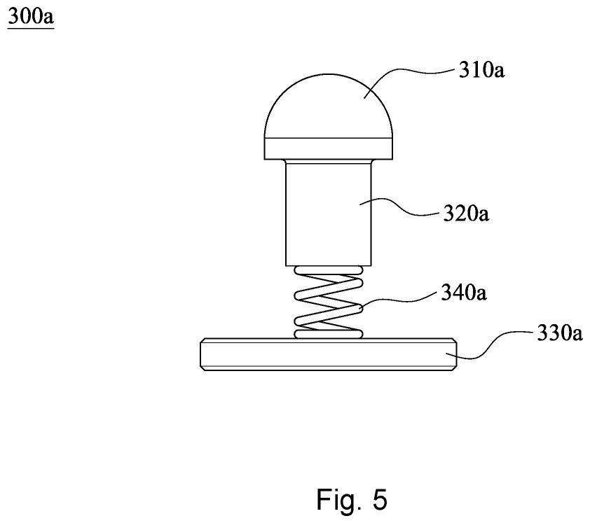

Please refer to FIG. 5 for the pushing element 300a in another embodiment of the present disclosure. The socket (not shown) according to the embodiment shown in FIG. 5 includes a socket body (not shown), a detent rod (not shown), and the pushing element 300a. The structures and arrangement of the socket body and the detent rod in the embodiment of FIG. 5 are the same as those of the socket body 100 and the detent rod 200 of the socket 10 according to the embodiment of FIG. 1 and therefore will not be described repeatedly. The pushing element 300a includes a domed portion 310a, a columnar body 320a, and a bottom portion 330a. The domed portion 310a, the columnar body 320a, and the bottom portion 330a may be respectively identical to the domed portion 310, the columnar body 320, and the bottom portion 330 in the embodiment of FIG. 1 and therefore will not be detailed. It is worth mentioning, however, that the pushing element 300a further includes an elastic element 340a. The elastic element 340a may be connected between the columnar body 320a and the bottom portion 330a or between the columnar body 320a and the domed portion 310a. In the embodiment shown in FIG. 5, the elastic element 340a is connected between the columnar body 320a and the bottom portion 330a. The elastic element 340a is so arranged that when a user pushes the detent rod and thereby drives the pushing element 300a to push a tool member engaged with the socket, the elastic element 340a is compressed and can therefore apply an elastic restoring force to, and thus push, the tool member while the user is trying to remove the tool member from the socket. Consequently, the difficulty of removing the tool member from the socket is reduced.

According to the above, the socket provided by the present disclosure has the following advantages: First, the detent rod and the pushing element are configured and arranged to allow effective removal of a tool member from the socket, thus reducing the difficulty of removing the tool member from the socket. Second, the positioning structure and the position-limiting grooves are configured and arranged to prevent the detent rod and the pushing element from inadvertent separation from the socket body. Third, the disc-shaped structure of the pushing element helps increase the strength with which the pushing element pushes a tool member.

While the present disclosure provides a description of the foregoing embodiments, it should be understood that those embodiments are not intended to be restrictive of the scope of the present disclosure. A person skilled in the art shall be able to change or modify the embodiments in various ways without departing from the spirit or scope of the present disclosure. The scope of patent protection sought by the applicant is defined by the appended claims.

What is claimed is:

1. A socket, comprising:
a socket body comprising:
an opening;
a teeth structure disposed on, and along a circumference of, an inner wall of the socket body; and
an abutting structure, wherein the abutting structure is farther away from the opening than is the teeth structure, and the abutting structure comprises:
a first through hole penetrating two sides of the abutting structure and being perpendicular to an axial direction of the socket body; and
a second through hole located at a center of the abutting structure and being in communication with and perpendicular to the first through hole;
a detent rod movably disposed through the first through hole, wherein the detent rod has a diminishing portion, and the diminishing portion tapers from two ends of the detent rod toward a center of the detent rod; and
a pushing element movably disposed through the second through hole, wherein the pushing element has an end abutting against the diminishing portion of the detent rod.

2. The socket of claim 1, wherein the diminishing portion has a sectional shape resembling a wedge-shaped recess.

3. The socket of claim 1, wherein the pushing element comprises:
a domed portion located at the end of the pushing element and abutting against the diminishing portion of the detent rod; and
a columnar body connected to the domed portion.

4. The socket of claim 3, wherein the abutting structure further comprises:
a positioning structure located at an end of the second through hole that is the closer to the opening;
wherein the domed portion has a greatest width (RA), the positioning structure has an inner diameter (RL), and the inner diameter (RL) of the positioning structure is less than the greatest width (RA) of the domed portion.

5. The socket of claim 1, wherein the pushing element has a second end having a greatest width greater than a diameter of the second through hole.

6. The socket of claim 5, wherein the pushing element comprises:
a bottom portion located at the second end of the pushing element.

7. The socket of claim 3, wherein the pushing element further comprises:
a bottom portion located at a second end of the pushing element; and
an elastic element connected between the columnar body and the bottom portion or between the columnar body and the domed portion.

8. The socket of claim 1, wherein the detent rod comprises:
a rod body comprising the diminishing portion; and
a cover member detachably connected to the rod body.

9. The socket of claim 1, wherein each of the two ends of the detent rod has an engaging portion, and the abutting structure further comprises:
two position-limiting grooves disposed in the two sides of the abutting structure respectively and corresponding to two ends of the first through hole respectively;
wherein each said engaging portion of the detent rod has a greatest width (RC), the first through hole has a diameter (R1), and the diameter (R1) of the first through hole is less than the greatest width (RC) of each said engaging portion of the detent rod.

10. The socket of claim 1, further comprising a stop ring, wherein the teeth structure comprises:
a groove disposed in, and along a circumference of, the teeth structure, wherein the stop ring is disposed in the groove.
